(19) United States
(12) Patent Application Publication
(10) Pub. No.: US 2002/0194428 A1
(43) Pub. Date: Dec. 19, 2002

(54) Method and apparatus for distributing raid processing over a network link

(75) Inventor: Henry J. Green, Blacksburg, VA (US)

Correspondence Address: FLEHR HOHBACH TEST ALBRITTON & HERBERT LLP, Suite 3400, Four Embarcadero Center, San Francisco, CA, 94111-4187, US

(73) Assignee: Intransa, Inc., a Delaware Corporation, Sunnyvale, CA

(21) Appl. No.: 10/113,333

(22) Filed: Mar. 29, 2002

Related U.S. Application Data
(60) Provisional application No. 60/280,588, filed on Mar. 30, 2001.

(51) Int. Cl. G06F 12/00

(52) U.S. Cl. 711/114; 711/170

(57) ABSTRACT

A client system makes a client request to read or write data according to a first protocol. The requests is received by an Array Management Controller which determines an associated storage location identifying at least one disk controller system and a corresponding memory location. The Array Management Controller translates the client request into a requests, which is sent to a disk controller system according to a second protocol. The disk controller system performs the client request and can perform parity calculation. The Array Management Controller combines the responses from each sent disk controller system request to generate a response into the client request. The client response is then sent to the client system according to a first protocol. Advantageously, a plurality of disk controller system can be used to perform parity calculations thereby reducing the parity calculations performed by the Array Management Controller.

### RELATION To CO-PENDING APPLICATION

This application claims priority to co-pending U.S. Provisional Patent Application No. 60/280,588, entitled, “Virtual Storage Network,” filed Mar. 30, 2001, David C. Lee et al. inventors, which is incorporated herein by reference.

### FIELD OF THE INVENTION

The present invention relates to the field of RAID storage and more specifically to distributing RAID processing over a network link, which may be unreliable.

### BACKGROUND OF THE INVENTION

RAID is an acronym for “Redundant Array of Independent (or Inexpensive) Disks”. RAID refers to a set of algorithms and methods for combining multiple disk drives into a virtual disk drive. RAID can be used to improve data integrity (risk of losing data due to a defective disk drive), improve performance, and reduce costs. Data is typically recorded in blocks, where a number of consecutive blocks make up a strip. A number of strips, which are stored on separate physical drives, make up a stripe, which is known in the art as disk striping (or RAID Level 0). Additionally, a check data strip can be added to the stripe, thereby supporting the reconstruction of a corrupted or lost strip within that stripe, based on the remaining user data strips and the check or parity data strips. In RAID Level 4 and RAID Level 5 systems, a parity strip is used as the check data strip. RAID Level 6 systems typically add a second check data strip to allow for reconstruction of two strips, such as in the event of two simultaneous disks failures.

FIG. 1 depicts a client computer 100 using an Array Management Controller 110 that functions according to a RAID algorithm with a number of physical disks 120-1, . . . 120-5. The Array Management Controller 110 typically presents a virtual disk 102, which may include a file 104, to the client computer. The file 104 may contain a number of data blocks, such as A, . . . , H, which may be determined and stored independently by the Array Management Controller 110. The Array Management Controller 110 typically keeps track of files 104, stripes 106-x associated with a file, strips 106-x-y associated with each stripe, parity associated with each stripe, and physical disks 120-x. A file 104 may be split into two stripes, 106-1 and 106-2, where each includes five data strips, 106-1-1 . . . 106-1-5 and 106-2-1 . . . 106-2-5. The contents of the file may be broken into eight data blocks A-H, with A-D written in the first stripe 106-1 to the physical disks 120-1, . . . , 120-4 as strip 106-1-1, . . . , 106-1-4, and data blocks E-H written in the second stripe 106-1 to the physical disks 120-1, . . . , 120-4 as strip 106-2-1, . . . , 106-2-4. A parity strip may also be written for each stripe 106-x such that lost data may be regenerated if one of the strips is lost. The physical disk 120-5 includes a strip 106-1-5 that contains the parity for strips A-D of the stripe 106-1, and 106-2-5 that contains the parity for strips E-H for stripe 106-2. Unfortunately, the Array Management Controller must generate the parity values.

The parity strip includes extra data that is typically generated as a function of the other data strips associated with the same data stripe. The parity strip, which may be calculated with an XOR function, provides a way by which a lost strip may be regenerated without the loss of any data. If any one of the data strips is lost, such as by a disk drive failure, then the data that was contained in the lost data strip can be reconstructed by combining the parity strip with the available data strips associated with the data stripe. As a result the data stored in a data stripe is not lost by the loss of a single strip.

An Array Management controller typically performs all array management functions, including but not limited to the task of mapping virtual disk volumes to physical member disk volumes, processing associated with reading and writing data to the member volumes, and the calculations required to maintain check data within the member disks. In a read request, the Array Management Controller determines which data blocks are associated with the data to be read, and the corresponding sets of data strips. When the data within each of the strips is returned to the Array Management controller, they are assembled into a format for use by the client system. In a write request, the Array Management Controller receives and splits data into a number of strips located on the member disks as a set of stripes (with corresponding check data if used). If parity is used, each data strip is used by the Array Management Controller to calculate a parity strip before storing the parity strip to a member disk.

Performance of existing RAID systems may be limited by the Array Management Controller's speed of parity calculations. A slight improvement in performance is provided by using a separate parity calculation engine coupled with the Array Management Controller, but a greater performance improvement could be achieved if the parity calculation were be distributed to many parity calculation engines, thus reducing a potential parity calculation bottleneck in the Array Management Controller.

Performance of existing Array Management Controller is also limited by a partial data stripe write, also known as the small write problem. Typically, each strip associated with a stripe is read by the Array Management Controller to calculate the parity strip. The Array Management Controller performance suffers because the Array Management Controller must read each strip, generate a parity strip, write the partial strip, and then write each data strip associated with the partial data stripe. Even higher performance could be produced if the Array Management Controller were only required to write the specific data strip containing the data to be stored, and the processing of writing the specific data strip could update the parity.

A variety of RAID architectures and algorithms were developed to provide alternative ways of enhancing Array Management Controller performance, reducing cost, and improving data integrity. Initially, six RAID architectures (or levels) were defined, denoted “RAID Level 0” to “RAID Level 5”. In this architecture data striping, mirroring, and parity, are the primary characteristics. Data striping provided a way of breaking data into stripes for storing individual stripes on different disk drives. Additionally, a data stripe could be partitioned into individual strips that can be interleaved across multiple disk drives. Stripes could be interleaved such that a virtual disk could be defined as including alternating strips from each drive. Mirroring provided a duplication of blocks of data across two disk drives, such that if one disk drive failed then the remain disk was still available and no data is lost. One or more drives are assigned to store a function of data stored (or parity), and if a disk drive fails, then the parity information could be combined with remaining data to regenerate the missing information.

FIG. 2-A depicts a client computer 100 housing a typical prior art Array Management Controller 110 that functions according to a RAID algorithm, and a number of physical disks 120-1, . . . 120-N. An Array Management Controller is coupled with multiple disk drives according to a reliable protocol such as SCSI or ATA, that allows the Array Management Controller to reliably communicate with each of the physical disk drives 120-1, . . . , 120-N. A request by the client computer 100 is received by the Array Management Controller and translated into a second set of requests, which are sent to the physical disks 120-1, . . . 120-N. The responses are then assembled by the Array Management Controller 110 to formulate a response to the client computer request.

In reading data, the client computer 100 makes a request for the data to the Array Management Controller 110. The Array Management Controller follows an algorithm to determine where the requested information is located, and requests each physical disk containing part of the data requested to provide the associated data. Parity information may also be requested based on the algorithm. Once all associated data is received, the controller can form a response to the client computer request. The Array Management Controller may also verify the data based on the parity information. Unfortunately, having to carry out such calculations can slow the prior art Array Management Controller performance. A further disadvantage of the architecture of FIG. 2-A is that each physical disk 120-x must be collocated near the associated Array Management Controller 110, and the maximum storage capacity is constrained.

In another attempt to improve storage capacity, but not necessarily to improve Array Management Controller performance an Internet SCSI (Small Computer System Interface) or ISCSI architecture was developed. FIG. 2-B depicts a client computer using an ISCSI driver 130 to communication with an IArray Management Controller 140 over an network according to an ISCSI protocol. The ISCSI driver 130 and the IArray Management Controller 140 provide a functionality similar to an Array Management Controller 110. The IArray Management Controller 140 may be coupled between an Internet Protocol (IP) network and the physical disks 120-1, . . . , 120-N, to translate between the ISCSI driver 130 and the physical disk 120-1 . . . N. The IArray Management Controller 140 may encodes and decodes communication with the ISCSI driver 130, and may perform the function of the Array Management Controller 110. Unfortunately, performance of the ISCSI system is limited by the speed of the ISCSI driver 130 and the IArray Management Controller 140, and the ability to calculate parity information, which is a very important aspect of most RAID systems. However the storage capability may be quite large.

Thus, there is a need for a system and a method for distributing RAID processing over a network link to improve RAID performance. The link may provide a reliable or an unreliable transport mechanism. Parity calculations should be performed across a network with limited interaction with an Array Management Controller. In a distributed RAID environment parity calculations should make efficient use of the network connection without unnecessarily requiring interaction with an Array Management Controller. This essentially splits the Array Management Controller's tasks and offloads the maintenance of check data and of parity calculations among the member disks and disk controller systems. Such system and method should exhibit improved performance over prior art Array Management Controllers, and should support a virtual storage system comprising many physical disks.

The present invention provides such a distributed RAID processing device and method.

### SUMMARY OF THE INVENTION

The present invention provides a system and method of executing a RAID algorithm in a distributed environment, which may be unreliable. A client system makes a client request to read or write data according to a first protocol. The request is received by an Array Management Controller that determines an associated storage location identifying at least one disk controller system and a corresponding memory location. The Array Management Controller translates the client request into at least one disk request, each of which is sent to a disk controller system according to a second protocol. The disk controller system performs the client request and can perform parity calculations. The Array Management Controller combines the responses from each sent disk controller system request to generate a response into the client request. The client response is then sent to the client system according to a first protocol. Advantageously, a plurality of disk controller system can be used to perform parity calculations thereby reducing the parity calculations performed by the Array Management Controller.

Other features and advantages of the invention will appear from the following description in which the preferred embodiments have been set forth in detail, in conjunction with the accompanying drawings.

### BRIEF DESCRIPTION OF THE FIGURES

FIG. 1 generally depicts a client computer 100 and Array Management Controller, according to the prior art;

FIG. 2-A generally depicts a client computer 100, according to the prior art;

FIG. 2-B generally depicts a client computer 100, coupled with an IArray Management Controller, according to the prior art;

FIG. 3 generally depicts an Array Management Controller in a distributed environment, coupled with a plurality of disk controllers, according to the present invention;

FIG. 4 generally depicts an ISCSI Array Management Controller in a distributed environment, coupled with a plurality of disk controllers, according to the present invention;

FIG. 5 depicts processing a client requests in a distributed environment, according to the present invention;

FIG. 6 depicts processing a client read requests in a distributed environment, according to the present invention;

FIG. 7 depicts processing a client write requests in a distributed environment, according to the present invention;

FIG. 8 depicts processing a disk controller system write requests or update parity request in a distributed environment, according to the present invention;

FIG. 9 depicts processing a disk controller system initialize parity requests in a distributed environment, according to the present invention;

FIG. 10 depicts processing a disk controller system read requests in a distributed environment, according to the present invention;

FIG. 11 depicts processing a disk controller system parity calculation requests in a distributed environment, according to the present invention;

FIG. 12 depicts the method on a computer readable media, according to the present invention;

FIG. 13 depicts the method executed by a computer system, according to the present invention.

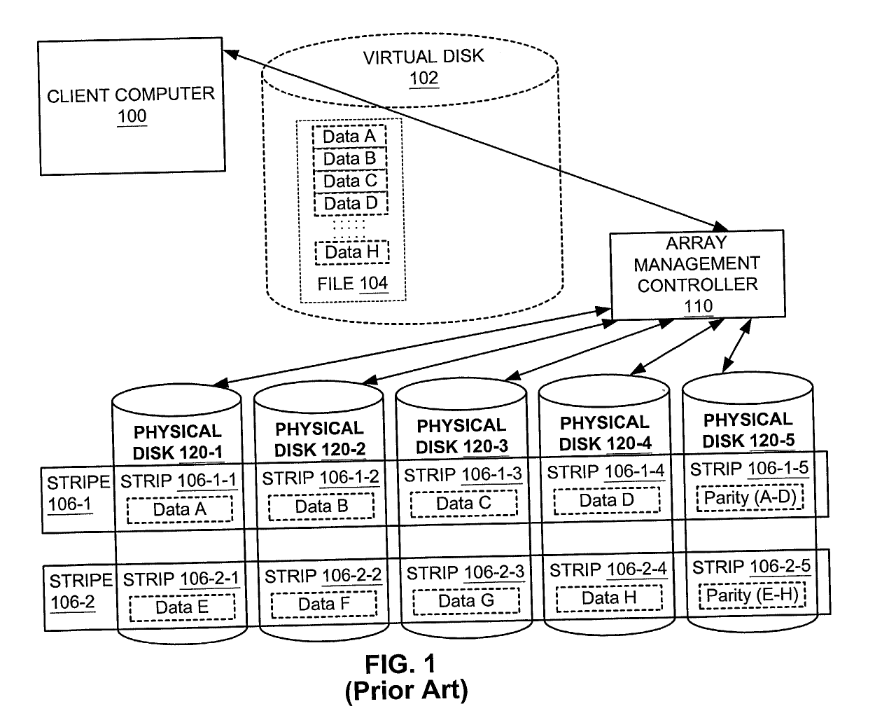

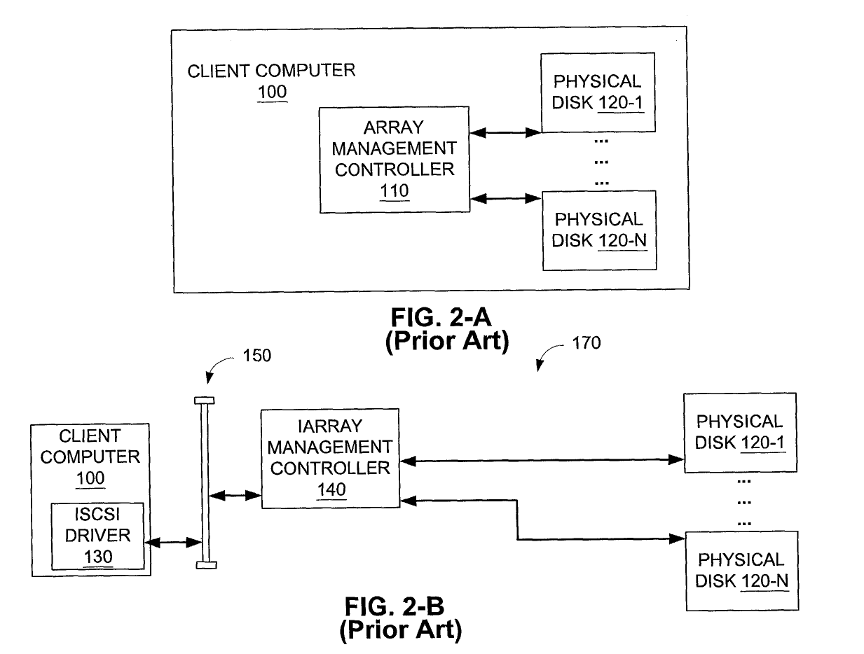

### DESCRIPTION OF THE INVENTION

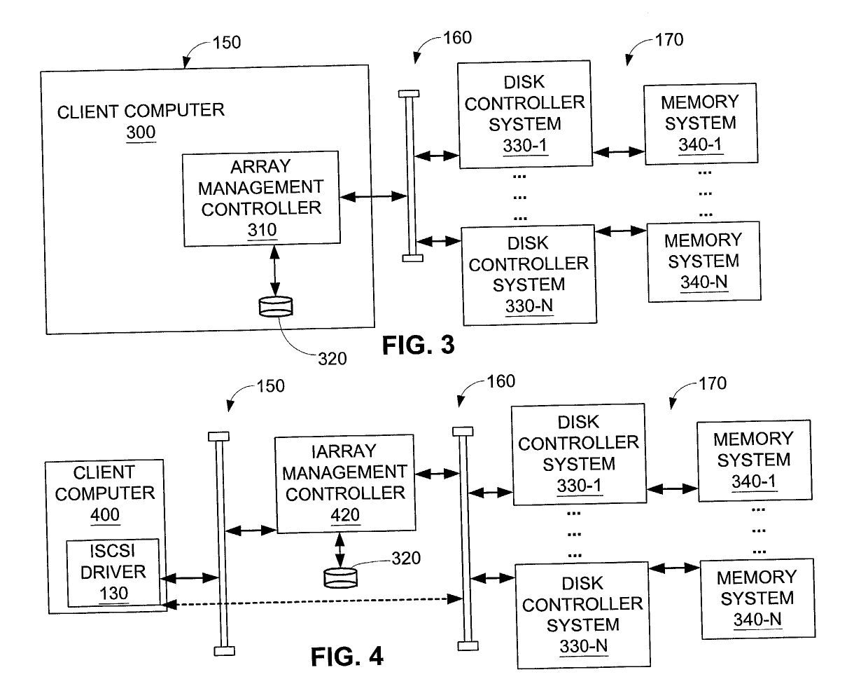

The present invention provides a method and apparatus for executing a RAID algorithm in a distributed environment, which may be unreliable. FIG. 3 generally depicts a client computer 300, including a Array Management Controller 310, and an Array Management Controller memory 320. The client computer 300 is coupled with the Array Management Controller to facilitate communication according to a first communication mechanism 150. Without limitation, the client computer 300 and Array Management Controller can communication according to any protocol supported by a common bus interface. The term Array Management Controller refers to Array Management Controller 310, unless noted otherwise.

The present invention also allows a disk controller system to regenerate data from other strips in a given stripe by supporting communication between disk controller systems. A disk controller system may send a requests to a second disk controller system associated with another strip associated with the same stripe. The second disk controller may collect the received data, may calculate regeneration data, and may send a reply or acknowledgment to the Array Management Controller. Advantageously, communication between disk controller systems can reduce the need for the Array Management controller to perform any check data calculations, and/or parity data calculations.

The Array Management Controller 310 is coupled to a second communication mechanism 160, which may be the same communication mechanism as the first 150, to facilitate communication with a plurality of disk controller systems 330-1, . . . , 330-N. As depicted the second communication mechanism 160 may be an Internet Protocol (IP) network that supports communication through the sending and receiving of network packets, such as Ethernet packets. Without limitation, the Array Management Controller 310 and disk controller systems 330-1, . . . , 330-N can communicate according to a protocol that supports the use of network packets.

Each disk controller system 330-1, . . . , 330-N is also coupled with a corresponding memory system (e.g., a disk drive, or RAM) 340-1, . . . , 340-N, to read and write data stored in the memory system, The disk controller system and corresponding memory system can communicate according to a third communication mechanism 170, such as SCSI, or ATA, without limitation. Multiple disk controller systems may communicate with the corresponding memory system according to a common third communication mechanism and an associated protocol 170. For example, each Disk-Controller System 330-1 . . . 5 may communicate with the corresponding memory system 340-1 . . . 5 over a common third communication mechanism and an associated protocol 170 such as a SCSI bus and SCSI protocol.

Using the Array Management Controller 310 and separate disk controller systems 330-x that can communicate with each other can enable a distributed environment, where different aspects of a RAID algorithm can be executed by the various components. Additionally, the three communication mechanisms 150, 160, and 170 tend to support a variety of interactions between individual components such that one component tends not to become a bottleneck to slowdown the process required to support the execution of the RAID algorithm.

Managing the allocation and deallocation of memory associated with the RAID virtual memory is typically the responsibility of the Array Management Controller, which maintains information identifying what information has been stored in the virtual memory and where it is located. An Array Management Controller memory 320 may be utilized by the Array Management Controller 310 to map information stored and the corresponding disk controller system and memory location within the corresponding memory system.

FIG. 4 show an embodiment in which the functionality of the Array Management Controller 310 is distributed between a client computer 400 including an ISCSI driver 130 and an IArray Management Controller 420. Typically the IArray Management Controller 420 encodes and decodes communication with the ISCSI driver 130, and performs the functions of the Array Management Controller 310. The ISCSI driver 130 may perform some aspects of the Array Management Controller functionality and the Array Management Controller 420 may perform the other aspects of the Array Management Controller functionality. The ISCSI driver 130 encapsulates communications according to a first communication mechanism and protocol 150, with the communications being sent to the IArray Management Controller 420. After receiving the encapsulated communication, the IArray Management Controller 420 can perform the same functions as though the IArray Management Controller 420 was directly accessible to the client computer 400. The IArray Management Controller 420 correspondingly encapsulates communications according to the first communication mechanism and protocol, with the communications being sent to the ISCSI driver 130. The term IArray Management Controller refers to Array Management Controller 410, unless noted otherwise.

A first communication mechanism and protocol is provided for communicating between the ISCSI driver 130 and the IArray Management Controller 420. A second communication mechanism is provided for communication between the IArray Management Controller 420 and the disk controller systems 330-1, . . . , 330-N, where the first and second communication mechanism and protocols may be the same. Communication between the ISCSI driver 130 and IArray Management Controller, and communication between the IArray Management Controller 420 and the disk controller systems is supported by a network, e.g., an IP network. Additionally, the IArray Management Controller may include an Array Management Controller memory 320 as described above.

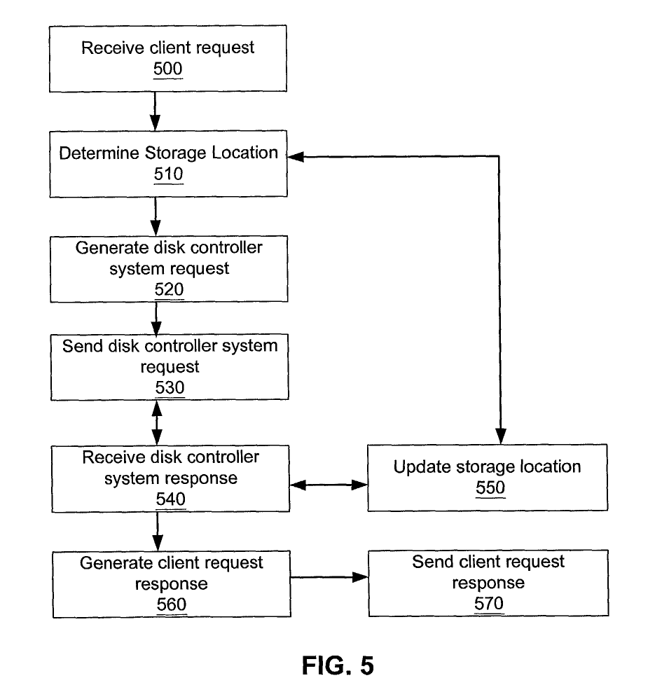

FIG. 5 depicts processing a client requests to read or write data associated with the virtual memory represented by the RAID system. The process associated with FIG. 5 can be associated with the an Array Management Controller 310 or within an IArray Management Controller 420, without limitation. At step 500 Array Management Controller receives a client request to read or write data associated with the RAID system. Each client request is typically associated with data stored or to be written into the RAID system. A read request is associated with information already stored, and requires a determination, of step 510, identifying the storage location. A write request may require the allocation of space, and require a determination of step 510 of the storage location where data associated with a client write request is to be written. An update may be made to the storage location information in step 550, which may correspond to an Array Management Controller memory 320.

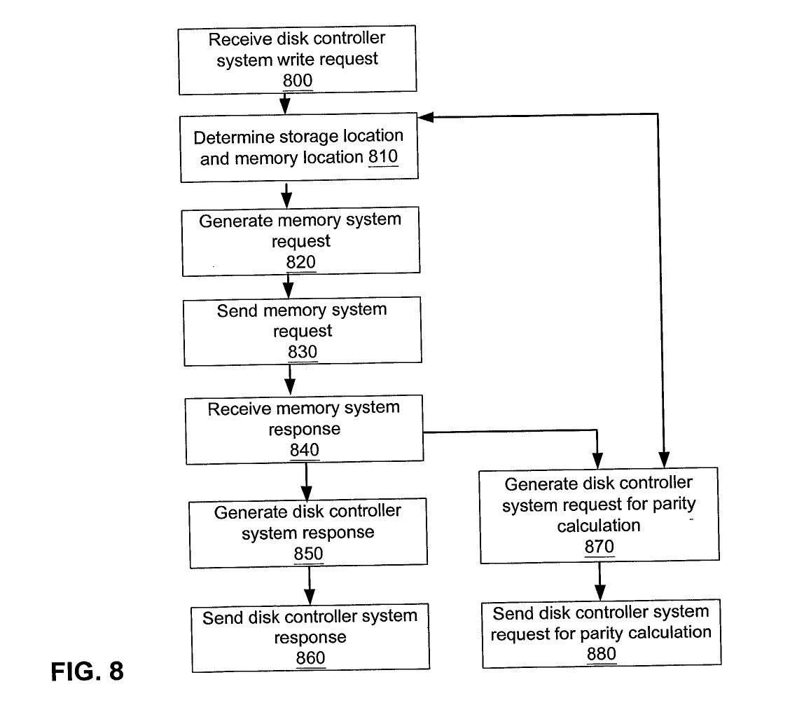

The determined storage location may identify any number of disk controller system that are associated with the client request. For each identified controller system, a request can be generated in step 520 for the specific disk controller system 330. A storage location determined at step 510 can be used to formulate the request and the storage location identifies at least one disk controller system and a corresponding memory location. Subsequently, the request is sent in step 530 to the disk controller system. As part of sending, the request may be translated into a protocol that is supported by the second communication mechanism 160, that supports communication between the corresponding Array Management Controller (e.g., 310) and a disk controller system (e.g., 330-1). Processing associated with the disk controller system request will be described with FIGS. 8-11.

The Array Management Controller may perform other activities while waiting to receive the disk controller system response of step 540, such as processing other client requests, monitoring the system, tracking requests and responses, and associating a timeout with requests. A timeout may be established to provide feedback if no response is received within an allotted amount of time then additional processing may be required, such as indicating the initial request has failed and/or re-sending the request. A response typically includes a status, or can be used to determine a status, of the corresponding request was successful or unsuccessful.

After receiving the response at step 540 the storage location may be updated according to step 550 based in part on the status of the response received at step 540. If the response was successful, then the associated memory may be identified as part of the client request. If the response was unsuccessful, then the associated memory may be identified as being available for subsequent client requests, or corrupted. Parity information may also be stored to indicate the success of a client operation, including interaction with any number of disk controller systems that may be associated with a client request.

A response to the initial client request can be generated at step 560, and then sent to the client in step 570. The generated response may include data requested and/or status determined by the corresponding status of each request sent at step 530 to fulfill the client request received at step 500. At step 570, the response is formatted according to the first communication mechanism, and an associated communication protocol 150.

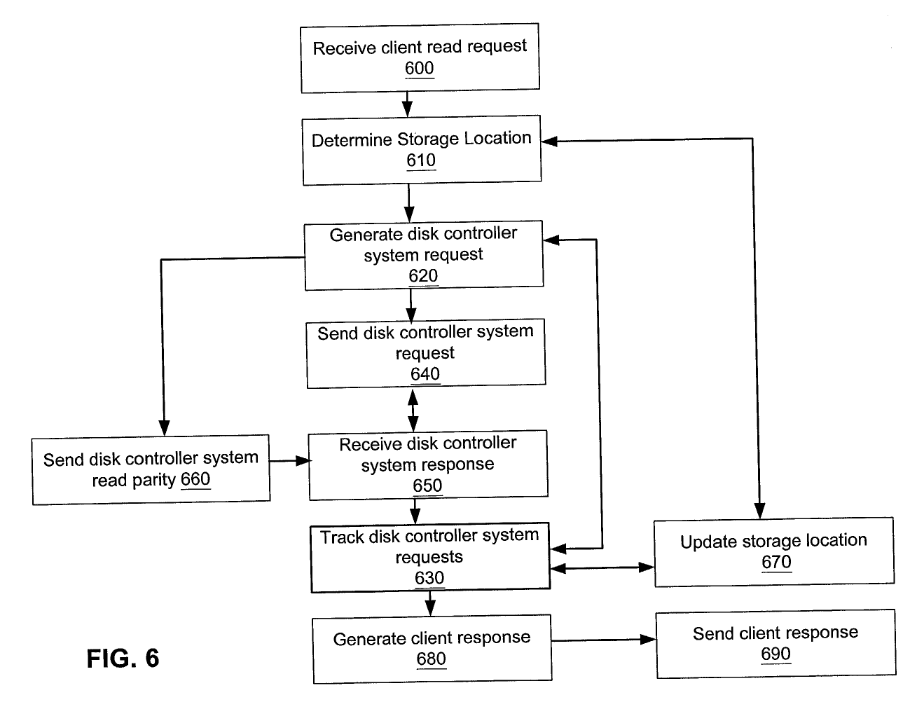

FIG. 6 depicts processing a client read requests in a distributed environment, according to the present invention. The process associated with FIG. 6 can be associated with the process within an Array Management Controller 310, or within an IArray Management Controller 420. An Array Management Controller receives a client read request at step 600 to read data that may have been previously stored in the RAID system. The read request may be based on blocks, such as blocks n to m, or may be based on a file type structure, such as a file “a.txt” that may be represented by blocks n to m. The read request requires a determination of the storage location at step 610. The determination may include accessing the Array Management Controller memory 320 to identify where the blocks are located in the RAID virtual memory. Assuming a single block was associated with the read request, then the Array Management Controller may identify the corresponding disk controller (e.g., 330-1) and the corresponding memory (e.g., 340-1). The read request may also be associated with multiple blocks.

A request can be generated at step 620 to a the specific disk controller system (e.g., 330-1) to read the identified memory. In other scenarios, a number of disk controller system requests 620 will be generated at step 620. Keeping track of disk controller system requests sent at steps 640, 660, and responses received at step 650 may be performed. The process of tracking requests and responses may include accessing and updating storage location information. Additionally, parity information may be read at step 660 to improve the integrity of the data corresponding to the read request. Requesting parity information is typically the same as a read request. Reading parity along with the required data does not ensure integrity, because the entire stripe must be read to perform a parity calculation, which would be compared with the read parity to ensure integrity. Calculating parity for comparison with the read parity requires a considerable amount of additional processing time and is therefore generally not performed.

At steps 640 and 660, the request is typically formatted according to the second communication mechanism and protocol 160. Tracking requests and responses may include verifying the status of each request, verifying the response based in part on parity information received, and potentially regenerate any missing or conflicting information. Missing or conflicting information may be regenerated based on responses received and parity information received.

The Array Management Controller may perform other activities while waiting to receive the disk controller system response of step 650, including tracking requests and responses at step 630, and timeout processing described above. Generating a client response and step 680, and sending the client response at step 690 may include status information and information requests by the client at step 600. Generating and sending of steps 680, 690 are similar to steps 560 and 570.

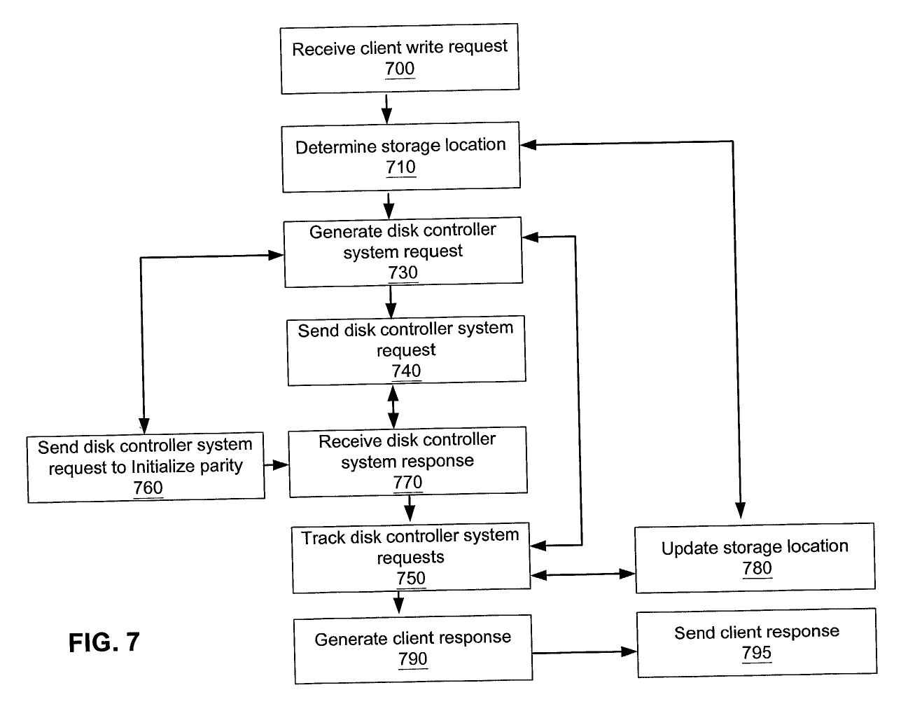

FIG. 7 depicts processing a client write request in a distributed environment, according to the present invention. The process associated with FIG. 7 can be associated with the process within an Array Management Controller 310, or within an IArray Management Controller 420. An Array Management Controller receives a client write request in step 700 to write data associated with the RAID system, to be stored in the RAID system. The write request may be based on blocks, such as blocks n to m, or may be based on a file type structure, such as a file “w.txt” that may be represented by blocks n to m. The write request requires a determination of where the blocks are to be stored according to a storage location at step 710. The storage location is typically determined in part by the Array Management mapping algorithm being implemented, which includes translating between the virtual blocks of the virtual volume to physical blocks on the member disk. The determination of storage location at step 710 includes identifying where the information is to be stored in the RAID virtual memory and where the corresponding information can be found. The determination may be used to update the storage location at step 780 that is potentially stored in an Array Management Controller memory 320. For example, the algorithm may require that a first write request is generated and sent to a first disk controller system, e.g., 330-1, which stores information associated with the write request. The first disk controller system may generate a second request, which is sent to a second disk controller system, including 1) a function of the contents of the first write request, and 2) a function of the parity storage location. The second disk controller system receives the second request and may perform a parity calculation to update and/or initialize the corresponding parity information, and may also generate and send a response to the first request, such as an acknowledgment or an error message.

Generating a write request to disk controller system may include two separate requests to write the file “w.txt”, according to a RAID algorithm. Here, a first request is generated at step 730 to write the data to be stored in the disk controller system (e.g., 330-1). The write request includes: 1) the blocks to be stored, 2) an identification of the corresponding memory location where the blocks are to be stored in the memory system (e.g., 340-1), and 3) an identification of the storage location of the corresponding parity information (e.g. 330-2, 340-2). Advantageously, the storage location of the corresponding parity information is provided because the disk controller system receiving the write request communicates with the disk controller system processing the parity, thereby minimizing parity calculations performed by an Array Management Controller.

A second request at step 730 includes an identification of the corresponding memory location where the parity information is to be stored in the memory system. The second request provides for initializing the parity to the disk controller system (e.g., 330-2) and does not include the file or the parity for the file. Unlike the prior art, Array Management Controller is not required to calculate the parity information. Instead the Array Management Controller perform an initialize parity request, and then formulate a write request for the associated disk controller system(s) to store information received in step 700 and each associated disk controller system may be required to support the parity calculation. For example, if a existing disk was replaced, e.g., 340-1, then the Array Management Controller may use the disk controller 330-1 to facilitate regenerating the information on the replaced disk 340-1. The Array Management Controller may initialize each strip which was used on replaced disk 340-1, and then request the regeneration of each strip based on the contents of other strips associated with the same stripe. Communication between the disk controller systems reduce processing required by the Array Management Controller. A disk controller system may regenerate the value of a given strip based on communications from other from other disk controller systems which contain a strip from the same stripe.

Generally, it will be appreciated that initializing parity must be completed before the parity calculation can be performed. In one embodiment, the initialization request of step 760 must be completed as determined by receiving a response at step 770 to the request before sending the disk controller system request at step 740 to write the data associated with the client request.

The Array Management Controller may perform other activities while waiting to receive the disk controller system response at step 770, and tracking requests and responses of step 750. Further, the timeout may be established as described above. Generating client response at step 790, and sending the client response at step 795 are similar to the descriptions above. A write request may require initializing a strip 760, such as a parity strip, before sending the disk controller system request 740. Generally, it will be appreciated that initializing a strip may require completion before other disk controller system requests are sent 740, such as when communication between disk controller systems is required, such as for the calculation of a parity strip.

Alternatively, the Array Management Controller may receive and/or generate a parity update request at step 730. The parity update request may be received from a client or from the Array Management Controller 310 as part of step 700 to regenerate a given strip. The update request may be processed as a write request to all strips, other than the given strip, within a stripe, such that the storage location of the given strip to be written is identified (including the associated disk controller system and memory location). The given strip may be processed as describe above for initialize parity. The given strip may be initialized according to steps 710, 730, and 760. An update parity request may be generated for each stip in the stripe, with the exception of the given strip. A subset of the strips in a given stripe may be sent an update parity request, depending on the algorithm implemented.

FIG. 8 depicts a disk controller system processing a write request or an update parity request in a distributed environment, according to the present invention. The process associated with FIG. 8 can be associated with a process executed by either a disk controller system (e.g., 330-1), or by an Array Management Controller 310. A disk controller system receives a write request or an update parity request at step 800 from an Array Management Controller 310, or from another disk controller system (e.g., 330-2). For a write request, information from the write request is used to determine a storage location identifying where the information is to be stored at step 810. Alternatively for a write request, determining a storage location at step 810 may be performed by the Array Management Controller 310 and communicated as part of the write request. For an update parity request information from the update parity request is used to determine a storage location identifying where the information is currently stored at step 810. Alternatively for an update parity request, determining a storage location at step 810 may be performed by the Array Management Controller 310 and communicated as part of the update parity request.

If processing a write request, then a request is then generated at step 820 to store the data associated with the write request at the location identified at step 810 within the corresponding memory system. In sending the request at step 830, the request may be translated according to the third communication mechanism and an associated protocol 170. The communication between a disk controller system (e.g., 330-1) and the corresponding memory system (e.g., 340-1) is supported by the third communication mechanism 170.

If processing a write request, the disk controller system may perform other activities while waiting to receive the memory system response at step 840, as described above, including tracking requests and responses, and timeout processing. Generating the disk controller system response at step 850 is performed to indicate the status, and/or an acknowledgment, of a write request. In sending the response at step 860, the response may be translated according to the second communication mechanism and an associated protocol 160. The communication between the disk controller system (e.g., 330-1) and the corresponding Array Management Controller system (e.g., 310) is supported by the second communication mechanism 160.

If processing a write request, depending on the RAID algorithm implemented, a disk controller system request may be generated to request a parity calculation at step 870. If the request received at step 800 was determined to have an associated storage location for parity information then a disk controller system request for parity calculation may be generated at step 870. The parity calculation request may include a function of the information included in the write request received at step 800. Alternatively, the parity calculation requests may include a duplicate of part or all information included in the write requests received at step 800. Advantageously, a disk controller system can communicate with other disk controller systems to distribute the functionality associated with prior Array Management Controllers 110. The parity calculation request, of step 870, is sent at step 880 and may be translated according to the second communication mechanism and an associated protocol 160. The communication between the disk controller system (e.g., 330-1) and other disk controller systems (e.g., 330-2) is supported by the second communication mechanism 160.

If processing an update parity request, then a request is then generated at step 820 to read the data associated with the update parity request at the location identified at step 810 within the corresponding memory system. In sending the request at step 830, the request may be translated according to the third communication mechanism and an associated protocol 170. The communication between a disk controller system (e.g., 330-1) and the corresponding memory system (e.g., 340-1) is supported by the third communication mechanism 170.

If processing an update parity request, the disk controller system may perform other activities while waiting to receive the memory system response at step 840, as described above, including tracking requests and responses, and timeout processing. Optionally, generating the disk controller system response at step 850 may be performed to indicate the status, and/or an acknowledgment, of a read request. In sending the response at step 860, the response may be translated according to the second communication mechanism and an associated protocol 160. The communication between the disk controller system (e.g., 330-1) and the corresponding Array Management Controller system (e.g., 310) is supported by the second communication mechanism 160.

If processing an update parity request, depending on the RAID algorithm implemented, a disk controller system request may be generated to request a parity calculation at step 870. The parity calculation can be used to regenerate a strip. If the request received at step 800 was determined to be an update parity request with an associated storage location for parity information then a disk controller system request for parity calculation may be generated at step 870. The parity calculation requests generated at step 870 may include a information received from step 840, or a function of the information received from step 840, in response to the read request generated at step 820, and sent at step 830. The parity calculation request may further include a function of the information included in the update parity request received at step 800 or determined at step 810. Advantageously, a disk controller system can communicate with other disk controller systems to distribute the functionality associated with prior Array Management Controllers 110. The parity calculation request, of step 870, is sent at step 880 and may be translated according to the second communication mechanism and an associated protocol 160. The communication between the disk controller system (e.g., 330-1) and other disk controller systems (e.g., 330-2) is supported by the second communication mechanism 160.

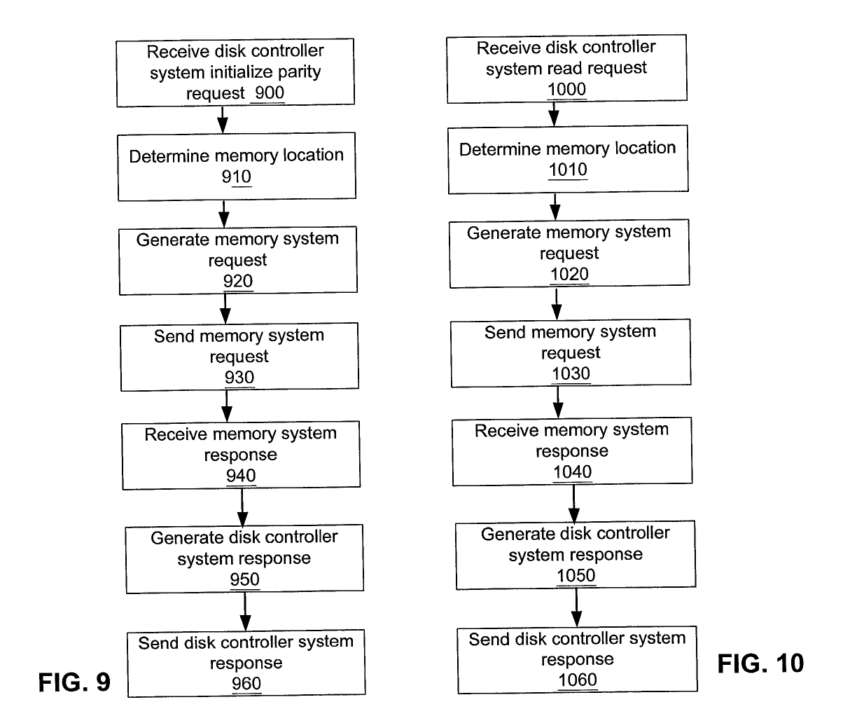

FIG. 9 depicts processing an initialize parity request by a disk controller system in a distributed environment, according to the present invention. The process associated with FIG. 9 can be associated with a process executed by a disk controller system (e.g., 330-2). A disk controller system receives an initialize parity request at step 900 from an Array Management Controller 310, or from another disk controller system (e.g., 330-1). Information from the initialize parity request is used to determine a memory location at step 910. Alternatively, determining a memory location at step 910 may be performed by the Array Management Controller or by another disk controller system.

A memory system request is then generated at step 920 to store the data associated with the initialize parity request at a determined memory location. A default initialization value of “0” may be used to initialize the determined memory location, In sending the request at step 930, the request may be translated according to the third communication mechanism and an associated protocol 170. The communication between the disk controller system (e.g., 330-2) and the corresponding memory system (e.g., 340-2) is supported by the third communication mechanism and protocol 170. The disk controller system may perform other activities while waiting to receive the memory system response at step 940 as described above.

Generating a disk controller system response at step 950 is performed to indicate the status of the request received at step 900. In sending the response at step 960, the response may be translated according to the second communication mechanism and an associated protocol 160. The communication between the disk controller system (e.g., 330-1) and the corresponding Array Management Controller (e.g., 310) is supported by the second communication mechanism 160.

The response sent at step 960 may be sent to the Array Management Controller or another disk controller system. Alternatively, the response sent at step 960 may be sent to both the Array Management Controller and the disk controller sending the initialize parity request. In one embodiment the system initialize parity request is generated by another disk controller system and the corresponding response is sent to the Array Management Controller.

FIG. 10 depicts processing a read request by a disk controller system in a distributed environment, according to the present invention. The process associated with FIG. 10 can be associated with a process executed on a disk controller system, e.g., 330-2. A disk controller system receives a read request at step 1000 from an Array Management Controller such as 310, or from another disk controller system, e.g., 330-1. Information from the read request is used to determine a memory location at step 1010. Alternatively, determining a memory location at step 1010 may be performed by the Array Management Controller or by another disk controller system.

A memory system request is then generated at step 1020 to read the data associated with the read request of step 1000 to request information stored in a memory system (such as 340-1) at a determined memory location at step 1010. In sending the request at step 1030, the request may be translated according to the third communication mechanism and an associated protocol 170. The communication between the disk controller system, e.g., 330-2, and the corresponding memory system, e.g., 340-2, is supported by the third communication mechanism 170. The disk controller system may perform other activities while waiting to receive the memory system response at step 940 as described above.

Generating a disk controller system response at step 950 is performed to indicate the status of the request and/or provide the information requested. In sending the response at step 1060, the response may be translated according to the second communication mechanism and an associated protocol 160. The communication between the disk controller system, e.g., 330-1, and the corresponding Array Management Controller, e.g., 310, is supported by the second communication mechanism.

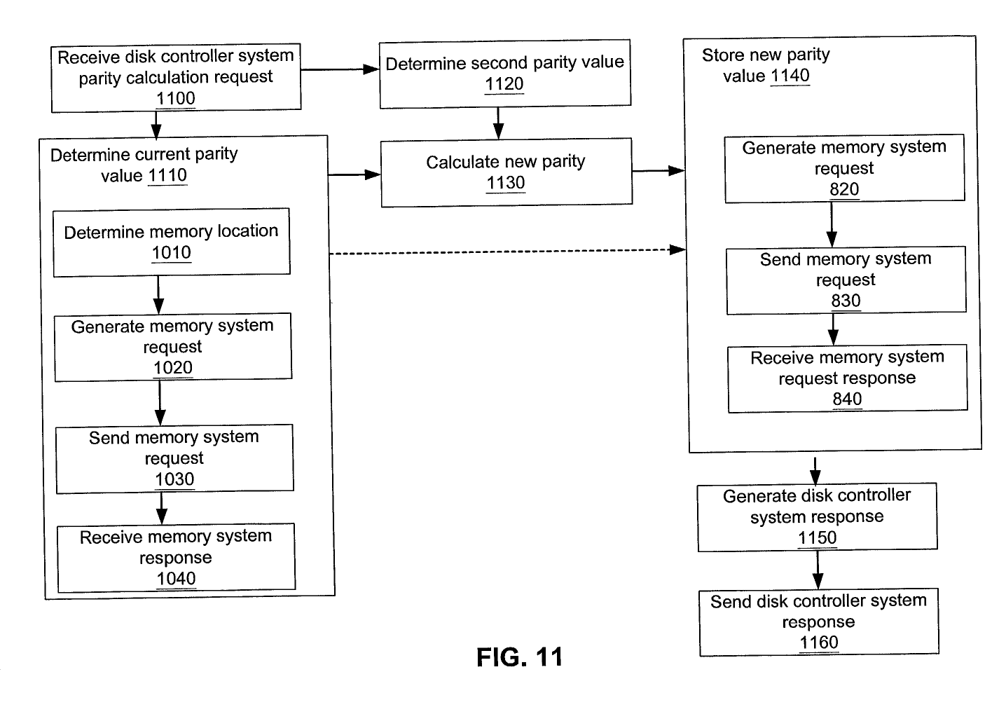

FIG. 11 depicts processing a parity calculation request sent to a disk controller system in a distributed environment, according to the present invention. The process associated with FIG. 11 can be associated with a process executed on a disk controller system, e.g., 330-2. A disk controller system receives a parity calculation request at step 1100 from an Array Management Controller 310, or from another disk controller system (e.g., 330-1). Information from the parity calculation request is used to determine the current parity value at step 1110, and to determine a second parity value at step 1120. Subsequently, the new parity value is calculated at step 1130 and stored at step 1140.

The current parity value is determined at step 1110 by reading the memory location as associated with FIG. 10, according to steps 1010, 1020, 1030, and 1040. The second parity value is determined at step 1120 based in part on the information in the parity calculation request at step 1100. The current parity value and the second parity value are used to calculate a new parity value at step 1130, such as by using a common XOR function. The new parity value is then stored at step 1140 in the corresponding memory system, described in part by steps 820, 830, 840. using the same memory location of the current parity value determined within at step 1110.

Generating a disk controller system response at step 1150 is performed to provide an acknowledgment and/or status of the request, In sending the response at step 1160, the response may be translated according to the second communication mechanism and an associated protocol 160. The communication between the disk controller system, e.g., 330-1, and the corresponding Array Management Controller, e.g., 310, is supported by the second communication mechanism and protocol 160.

The response sent at step 1160 may be sent as an acknowledgment to the Array Management Controller or another disk controller system, which sent the parity calculation request. Alternatively, the response sent at step 1160 may be sent to both the Array Management Controller and the disk controller sending the parity calculation request. In one embodiment the parity calculation request is requested by another disk controller system and the corresponding response is sent to the Array Management Controller.

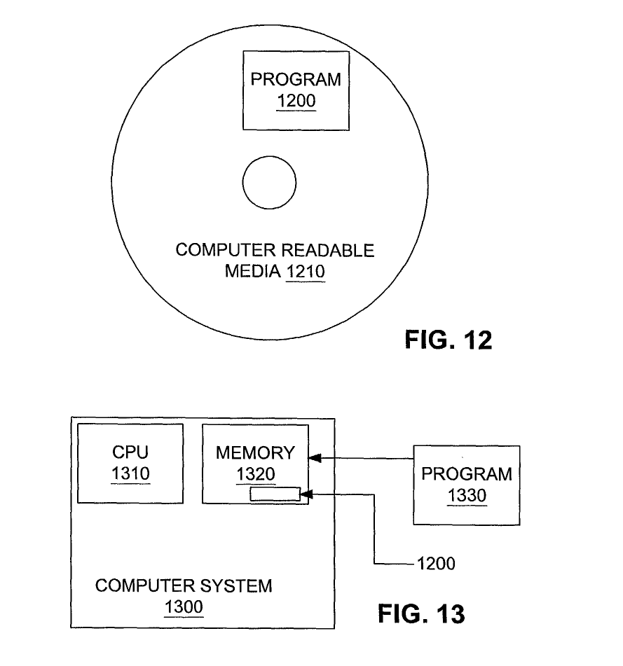

FIG. 12 depicts the method according to the present invention on a computer readable media. A program 1200 representing the functionality of at least one of the following: performed by an Array Management Controller 310 or IArray Management Controller 420, disk controller system, and memory system. The program 1200 is coupled with a computer readable media 1210, such that the a computer system could read and execute the program 1200.

FIG. 13 depicts a computer system 1300 including a CPU 1310 and a memory 1320. The program 1200 is loaded into a memory 1320 accessible to the computer system 1300, which is capable of executing the program 1200. Alternatively, the program 1200 may be permanently embedded in the memory 1320.

In one embodiment the method of executing an Array Management Controller algorithm in a distributed environment, which may be unreliable, includes a series of steps. Step (A) includes receiving a client request to read or write data, according to a first protocol 150. Step (B) includes determining a storage location associated with the client request, the storage location identifies at least one controller system and a corresponding memory location. Step (C) includes translating the client request into at least one controller system request responsive to a determination made at step (B). Step (D) includes sending each controller system request translated at step (C), according to a second protocol 160. Step (E) includes receiving at least one controller system response to each controller system request sent at step (D), according to said second protocol. The response may be determined based on a timeout and/or the absence of a response. Step (F) includes translating said response at step (E) into a client request response. Step (G) includes sending to said client system the client request response translated at step (F), according to the first protocol 150.

Calculating parity may be performed by at least one disk controller system. A first disk controller system may be associated with a memory system storing the parity, and other disk controller system that are associated with a memory system storing a strip corresponding to the same stripe may communicate with the first disk controller system to facilitate the first disk controllers parity calculation. A storage location may be used by an Array Management Controller 310 and/or disk controller systems to identify the location of corresponding information, typically including a disk controller system and a corresponding memory location. A storage location may also identify a corresponding parity storage location, which identifies of at least one disk controller system and the corresponding memory locations.

In one embodiment, Step (A) may comprise receiving a client request to write data associated with a memory in said RAID, according to a first protocol. Step (B) may further include determining at least one data stripe associated with said client request, said data stripe including a plurality of strips, each strip associated with a corresponding storage location, said plurality of strips including at least one data strip and at least one parity strip. Step (C) may further included or comprise translating each data stripe of step (B) into at least one disk controller system request, responsive to each data strip determined at step (B), and identifying each parity strip. Step (H) may be included to support calculating and/or storing parity using at least one disk controller system.

In another embodiment, each data stripe may be translated into a least one disk controller system request to initialize parity of at least one parity strip associated with the data stripe. Typically, initialization of parity is performed and/or verified before sending other commands associated with the same parity stripe.

In yet another embodiment, a disk controller system may receive requests from an Array Management Controller system or from a disk controller system, selected from a set including (a) read, (b) write, (c) initialize parity, (d) parity calculation, and (e) update parity, according to a second protocol. After receiving requests, the disk controller system may determine a storage location associated with the request, the storage location identifying at least one corresponding memory location. The disk controller system may translate the request into at least one memory system request responsive to the determined storage location, and send each memory system request translated, according to a third protocol. The disk controller system may receive at least one memory system response to each memory system request sent, which are translated into a request response, responsive to received request. The request response is sent, according to the second protocol.

According to another embodiment an Array Management Controller may generate a read request, which is sent to a disk controller system. The disk controller system responds to the read request with an acknowledgment, which may include data associated with the disk controller system and/or a memory system. If no response is received by the Array Management Controller with a default or specified amount of time, then the Array Management Controller may 1) resend the read request, 2) generate a second read request that is sent to the disk controller system, or 3) indicate the request has failed.

According to another embodiment an Array Management Controller may generate a write request, which is sent to a disk controller system. The Array Management Controller may track the write request by storing requests and responses. The Array Management Controller memory 320 may include storage location and a parity status associated with the write request, where the parity status may be set to dirty. The disk controller system may respond to the write request with an optional acknowledgment that the write was completed. The disk controller system can generates an parity calculation request, which is sent to the disk controller system containing the parity information, without interacting with the Array Management Controller. The disk controller system receiving the parity calculation request may perform the parity calculation and may respond to the parity calculation request with an optional acknowledgment that the parity calculation was completed.

The foregoing descriptions of specific embodiments and best mode of the present invention have been presented for purposes of illustration and description. They are not intended to be exhaustive or to limit the invention to the precise forms disclosed, and obviously many modifications and variations are possible in light of the above teaching. The embodiments were chosen and described to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A method of executing an Array Management Controller algorithm in a distributed environment, which may be unreliable, the method comprising:
(A) receiving a client request to read or write data, according to a first protocol;
(B) determining a storage location associated with said client request, said storage location identifying at least one disk controller system and a corresponding memory location;
(C) translating said client request into at least one disk controller system request responsive to a determination made at step (B);
(D) sending each disk controller system request translated at step (C), according to a second protocol;
(E) receiving at least one disk controller system response to each controller system request sent at step (D), according to said second protocol;
(F) translating said response at step (E) into a client request response; and
(G) sending to said client system said client request response translated at step (F), according to said first protocol.

2. The method of claim 1, further including:
determining a parity storage location corresponding to said storage location, said parity storage location identifies at least one disk controller system and a corresponding memory location; and
calculating said parity.

3. The method of claim 2, wherein said calculating said parity further includes storing said parity.

4. The method of claim 2, wherein calculating said parity is performed on at least one disk controller system.

5. The method of claim 4, further including initializing said memory location of said parity storage location and then calculating and storing said parity.

6. The method of claim 1, wherein:
step (A) comprises receiving a client request to write data, according to a first protocol;
step (B) further includes determining at least one data stripe associated with said client request, said data stripe including a plurality of strips, each strip associated with a corresponding storage location, said plurality of strips including at least one data strip and at least one parity strip;
step (C) translating each data stripe of step (B) into at least one disk controller system request:
responsive to each data strip determined at step (B), and
identifying each parity strip; and further including
(H) calculating and storing said parity using at least one disk controller system.

7. The method of claim 6, wherein:
step (C) further includes translating each data stripe of step (B) into a least one disk controller system request to initialize parity of at least one parity strip determined at step (B).

8. The method of claim 7, wherein initialize parity is at step (C) is performed before sending at step (D).

9. A method of executing an Array Management Controller algorithm in a distributed environment, which may be unreliable, the method comprising:
(A) receiving a request, from an Array Management Controller system or from a disk controller system, selected from a set including (a) read, (b) write, (c) initialize parity, (d) parity calculation, and (e) update parity, according to a second protocol;
(B) determining a storage location associated with said request, said storage location identifying at least a corresponding memory location;
(C) translating said request into at least one memory system request responsive to a determination made at step (B);
(D) sending each memory system request translated at step (C), according to a third protocol;
(E) receiving at least one memory system response to each memory system request sent at step (D);
(F) translating said response at step (E) into a request response, responsive to said request at step (A); and
(G) sending said request response translated at step (F), according to said second protocol.

10. The method of claim 9, wherein:
step (A) comprises receiving a write request;
step (B) further includes determining at least one parity storage location:
associated with said parity strip,
identifying at least one disk controller system; and
a corresponding memory location;
step (C) further includes translating said request into at least one requests responsive to a determination of parity storage location made at step (B), including:
determining a second parity value as a function of said write request; and
translating said disk controller system request into at least one parity calculation request responsive to said determining at step (B); and
step (D) further includes sending each disk controller system request translated at step (C), according to said second protocol.

11. The method of claim 9, wherein:
step (D) further includes sending an acknowledgment to said Array Management Controller system identifying at least one disk controller system request at step (D), according to said first protocol.

12. The method of claim 9, wherein
step (A) comprises a parity calculation request;
step (C) (D) and (E) are performed in determining a current parity value of the memory location determined at step (B);
steps (B) further includes determining a second parity value; further including
calculating new parity as a function of said current parity value and said second parity value; and
steps (C) (D) and (E) are performed in storing said new parity value to the memory location determined at step (B).

13. The method of claim 12, wherein
step (B) further includes identifying an Array Management Controller system; and
storing new parity value is acknowledged to said Array Management Controller system.

14. The method of claim 12, wherein said calculating parity is an XOR function.

15. A method of executing an Array Management Controller algorithm in a distributed environment, which may be unreliable, the method comprising:
(A) receiving a client request to read or write data, according to a first protocol;
(B) determining a storage location associated with said client request, said storage location identifying at least one disk controller system and a corresponding memory location; and determining at least one data stripe associated with said client request, said data stripe including a plurality of strips, each strip associated with a corresponding storage location, said plurality of strips including at least one data strip and at least one parity strip;
(C) translating said client request into at least one disk controller system request responsive to a determination made at step (B); and translating each data stripe of step (B) into at least one disk controller system request:
responsive to each data strip determined at step (B), and
identifying each parity strip; and
further includes translating each data stripe of step (B) into a least one disk controller system request to initialize parity of at least one parity strip determined at step (B); wherein initializing parity at step (C) is performed before sending at step (D);
(D) sending each disk controller system request translated at step (C), according to a second protocol;
(1) receiving from a request, from an Array Management Controller system or from a disk controller system, selected from a set including (a) read, (b) write, (c) initialize parity, (d) parity calculation, and (e) update parity, according to a second protocol;
(2) determining a storage location associated with said request, said storage location identifying at least a corresponding memory location;
(3) translating said request into at least one memory system request responsive to a determination made at step (2);
(4) sending each memory system request translated at step (3), according to a third protocol;
(5) receiving at least one memory system response to each memory system request sent at step (4);
(6) translating said response at step (5) into a request response, responsive to said request at step (1);
(7) sending said request response translated at step (6), according to said second protocol;
(E) receiving at least one disk controller system response to each disk controller system request sent at step (D), according to said second protocol;
(F) translating said response at step (E) into a client request response; and
(G) sending to said client system said client request response translated at step (F), according to said first protocol;
(H) calculating and storing said parity using at least one disk controller system.

16. The method of claim 15, wherein:
step (1) comprises receiving a write request;
step (2) further includes determining at least one parity storage location:
associated with said parity strip,
identifying at least one disk controller system; and
a corresponding memory location;
step (3) further includes translating said request into at least one requests responsive to a determination of parity storage location made at step (2), including:
determining a second parity value as a function of said write request; and
translating said disk controller system request into at least one parity calculation request responsive to said determining at step (2B); and
step (4) further includes sending each disk controller system request translated at step (3), according to said second protocol.

17. A system for executing an Array Management Controller algorithm in a distributed environment, which may be unreliable, wherein a client request to read or write data, according to a first protocol, the system comprising:
a means for determining a storage location associated with said client request, said storage location identifying at least one disk controller system and a corresponding memory location;
a first means for translating said client request into at least one disk controller system request responsive to a determination made by said means for determining;
a first means for sending each disk controller system request translated by said first means for translating, according to a second protocol;
a means for receiving at least one disk controller system response to each disk controller system request sent by said first means for sending, according to said second protocol;
a second means for translating said response in said means for receiving into a client request response; and
a second means for sending to said client system said client request response translated by said second means for translating, according to said first protocol.

18. The system of claim 17, further including:
means for determining a parity storage location identifying at least one disk controller system and a corresponding memory location;
means for calculating parity on at least one disk controller system; and
means for storing said parity.

19. The system of claim 17, comprises receiving a client request to write data associated with a memory in said RAID, wherein:
said means for determining further includes determining at least one data stripe associated with said client request, said data stripe including a plurality of strips, each strip associated with a corresponding storage location, said plurality of strips including at least one data strip and at least one parity strip;
said first means for sending further includes translating each data stripe of said first means for translation into at least one disk controller system request:
responsive to each data strip determined by said means for determining, and
identifying each parity strip; and further including
means for calculating parity; and
means for storing parity using at least one disk controller system.

20. The system of claim 19, wherein:
said first means for translating further includes translating each data stripe identified by said first means for determining into at least one disk controller system request to initialize parity of at least one parity strip determined by said means for determining.

21. The system of claim 20, wherein said means for calculating parity is performed before said means for calculating parity.

22. A system for executing an Array Management Controller algorithm in a distributed environment, which may be unreliable wherein a request, from an Array Management Controller system or from a disk controller system, selected from a set including (a) read, (b) write, (c) initialize parity, (d) parity calculation, and (e) update parity, according to a second protocol, the system comprising:
a means for determining a storage location associated with said request, said storage location identifying at least a corresponding memory location;
a first means for translating said request into at least one memory system request responsive to a determination by said means for determining;
a first means for sending each memory system request translated according to said first means for translating, according to a third protocol;
a means for receiving at least one memory system response to each memory system request sent according to said first means for sending;
a second means for translating said response of said means for receiving into a request response, responsive to said request; and
a second means for sending said request response translated by second means for translating, according to said second protocol.

23. The system of claim 22, wherein said request is a write request, the system further comprising:
said means for determining further includes determining at least one parity storage location,
associated with said parity strip,
identifying at least one disk controller system; and
a corresponding memory location;
said first means for translating further includes translating said request into at least one requests responsive to a determination of parity storage location made by said means for determining including:
second means for determining a second parity value as a function of said write request; and
third means for translating said disk controller system request into at least one parity calculation request responsive to said determining of said means for determining; and
first means for sending further includes sending each disk controller system request translated by first means for translating, according to said second protocol.

24. The system of claim 9, wherein:
first means for sending further includes sending an acknowledgment to said Array Management Controller system identifying at least one disk controller system request sent according to said first means for sending, according to said first protocol.

25. The system of claim 9, said request is a parity calculation request, wherein
a means for determining current parity value of the memory location determined by said means for determining including:
said first means for translating;
said first means for sending; and
said means for receiving;
said means for determining further includes determining a second parity value; further including;
means for calculating new parity as a function of said current parity value and said second parity value; and
means for storing said new parity value to the memory location determined by said means for determining including:
said first means for translating;
said first means for sending; and
said means for receiving.

26. The system of claim 25, wherein
said means for determining further includes identifying an Array Management Controller system; and
means for acknowledging storing new parity value to said Array Management Controller system.

27. The system of claim 25, wherein said means for calculating new parity includes an XOR function.
